(19) United States
(12) Patent Application Publication
(10) Pub. No.: US 2026/0170655 A1
(43) Pub. Date: Jun. 18, 2026

(54) MULTI-SENSOR PERCEPTION WITH AUXILIARY DEPTH SUPERVISION

(71) Applicant: QUALCOMM Incorporated, San Diego, CA (US)

(72) Inventors: Diptiben Navinchandra Patel, San Diego, CA (US); Madhumitha Sakthi, Dublin, CA (US); Amin Ansari, Kirkland, WA (US); Sai Madhuraj Jadhav, Foster City, CA (US)

(21) Appl. No.: 18/984,394

(22) Filed: Dec. 17, 2024

(51) Int. Cl. G06T 7/11; G06T 5/50; G06T 7/73

(52) U.S. Cl. CPC G06T 7/11; G06T 5/50; G06T 7/73; G06T 2207/10028; G06T 2207/20221; G06T 2207/30256

(57) ABSTRACT

An apparatus may be configured to perform a perception task may receive a camera image of a scene from a camera sensor, receive depth data of the scene from a depth sensor, process the camera image with a first feature extractor to generate camera features, process the depth data with a second feature extractor to generate depth features, determine grids of the camera image based on the depth data, process the grids of the camera image with the first feature extractor to form ROI features, region-of-interest (ROI) align the ROI features to form aligned features, combine the camera features, the depth features, and the aligned features to generate combined features, and perform a perception task using the combined features.

### TECHNICAL FIELD

This disclosure relates to computer vision techniques.

### BACKGROUND

Computer vision applications, including applications in automotives, make use of the detection and analysis of three-dimensional (3D) objects. 3D object detection may include the identification and localization of objects in 3D space using sensors like cameras, LiDAR, and RADAR. Algorithms process this data to recognize and position objects accurately, enhancing real-time situational awareness.

Example computer vision tasks for automotive application include semantic occupancy prediction, semantic segmentation, lane tracking, and 3D object detection. Semantic occupancy prediction involves predicting the presence and category of objects in a 3D space, typically represented as a grid or voxel space, helping to understand the structure and content of the environment. Semantic segmentation is the process of classifying each pixel in an image into predefined categories, enabling more precise identification and localization of different objects and regions within the image. Lane tracking involves identifying and following lane markings in images or video frames, which is important for autonomous driving systems to navigate and stay within traffic lanes accurately. 3D object detection aims to identify and localize objects within a 3D space, providing detailed information about the position, dimensions, and categories of objects in the environment.

### SUMMARY

In general, this disclosure describes techniques for performing perception tasks that may be used in computer vision and automotive use cases. In particular, this disclosure describes techniques for combining depth data with camera data to improve depth estimation of the camera data during a view transformation. Improved depth estimation may in turn improve the output of perception tasks performed using the combined depth data and camera data.

In a more specific example of the disclosure, an apparatus configured for performing a perception task may be configured to combine first information associated with a camera image with second information associated with depth data from a depth sensor. In one example, the combining of the first information and the second information may occur “early” in a perception pipeline (e.g., before feature extraction) or may occur in a “middle” part of the perception pipeline (e.g., after feature extraction).

Accordingly, in an early fusion example of the disclosure, the first information associated with the camera image may be pixel values, while the second information associated with the depth data may be depth parameters (e.g., a RADAR cross section and absolute velocity in the context of a RADAR depth sensor). In a mid fusion example of the disclosure, the first information associated with the camera image may be feature vectors produced by processing the camera image with a camera feature extractor. Likewise, in the mid fusion example, the second information associated with the depth sensor may be feature vectors produced by processing the depth data with a depth feature extractor.

Regardless of when the first information and second information are combined to form the combined data, the apparatus may perform a view transformation (e.g., a birds-eye-view (BEV) transform) on features generated from the combined data. The view transformation process includes performing a depth estimation. The apparatus may then fuse the transformed features generated from the combined data with features generated from the depth data to form fused BEV features. One or more perception tasks may then be performed on the fused BEV features. Perception tasks may include one or more of sematic segmentation, semantic occupancy prediction, lane tracking, object tracking, collision prediction, 3D object detection, or 3D object classification.

In one example, this disclosure describes an apparatus for performing a perception task, the apparatus comprising one or more memories, and processing circuitry in communication with the one or more memories, the processing circuitry configured to receive a camera image of a scene from a camera sensor, receive depth data of the scene from a depth sensor, process the camera image with a first feature extractor to generate camera features, process the depth data with a second feature extractor to generate depth features, determine grids of the camera image based on the depth data, process the grids of the camera image with the first feature extractor to form ROI features, combine the camera features, the depth features, and the ROI features to generate combined features, and perform a perception task based on the combined features.

In another example, this disclosure describes a method for performing a perception task, the method comprising receiving a camera image of a scene from a camera sensor, receiving depth data of the scene from a depth sensor, processing the camera image with a first feature extractor to generate camera features, processing the depth data with a second feature extractor to generate depth features, determining grids of the camera image based on the depth data, processing the grids of the camera image with the first feature extractor to form ROI features, combining the camera features, the depth features, and the ROI features to generate combined features, and performing a perception task based on the combined features.

In another example, this disclosure describes a device for performing a perception task, the device comprising means for receiving a camera image of a scene from a camera sensor, means for receiving depth data of the scene from a depth sensor, means for processing the camera image with a first feature extractor to generate camera features, means for processing the depth data with a second feature extractor to generate depth features, means for determining grids of the camera image based on the depth data, means for processing the grids of the camera image with the first feature extractor to form ROI features, means for combining the camera features, the depth features, and the ROI features to generate combined features, and means for performing a perception task based on the combined features.

In another example, this disclosure describes a non-transitory computer-readable storage medium storing instructions that, when executed, cause one or more processors of a device configured to perform a perception task to receive a camera image of a scene from a camera sensor, receive depth data of the scene from a depth sensor, process the camera image with a first feature extractor to generate camera features, process the depth data with a second feature extractor to generate depth features, determine grids of the camera image based on the depth data, process the grids of the camera image with the first feature extractor to form ROI features, combine the camera features, the depth features, and the ROI features to generate combined features, and perform a perception task based on the combined features.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle in accordance with the techniques of this disclosure.

FIG. 2 is a block diagram illustrating an example system that may perform the techniques of this disclosure.

FIG. 3 is a block diagram illustrating one example of multi-sensor perception with auxiliary depth supervision in accordance with the techniques of this disclosure.

FIG. 4 is a block diagram illustrating an example of depth and camera fusion according to a first example of the disclosure.

FIG. 5 is a block diagram illustrating another example of depth and camera fusion according to a second example of the disclosure.

FIG. 6 is a block diagram illustrating another example of depth and camera fusion according to a third example of the disclosure.

FIG. 7 is a flowchart illustrating one example process in accordance with the techniques of this disclosure.

FIG. 8 is a flowchart illustrating another example process in accordance with the techniques of this disclosure.

### DETAILED DESCRIPTION

In some example perception models for computer vision, 3D depth data from a depth sensor (e.g., a RADAR point cloud) is processed by a depth feature extractor to obtain depth feature vectors. The 3D depth features vectors may then be flattened into a birds-eye-view (BEV) representation. Additionally, one or more camera images captured at approximately the same time as the 3D depth data may be processed by a camera feature extractor to obtain camera feature vectors. These camera feature vectors may be processed by a view transformation to convert the camera features from perspective views into the same BEV representation as the depth feature vectors. One example of a view transformation is lift, shoot, splat. As part of the lift, shoot, splat process, implicit depth estimation is performed for each of the camera feature vectors.

A BEV representation in computer vision refers to a top-down perspective of a scene, as if viewed from above, similar to the perspective of a bird flying overhead. A BEV representation is particularly valuable in applications such as autonomous driving, robotics, and surveillance, where understanding the spatial layout and relationships between objects on the ground plane is beneficial. In the context of computer vision, generating a BEV representation involves transforming image data from one or more cameras into a top-down view. This top-down perspective simplifies various tasks in computer vision, such as object detection, tracking, and path planning, by reducing the complexity of the scene and offering a more intuitive understanding of spatial relationships. Additionally, as discussed above, BEV representations are often integrated with data from other sensors, such as LiDAR or RADAR, to enhance accuracy and robustness in dynamic and complex environments.

After transformation to the BEV representation, the depth feature vectors and the camera feature vectors may be fused into BEV feature vectors. One or more perception tasks, such as 3D object detection, lane detection, object tracking and segmentation tasks, may then be performed on the BEV feature vectors. The general perception model described above may be trained to learn an implicit depth representation for each pixel in the perspective view to transform features from perspective view to the BEV representation. However, the model is only trained to determine the implicit depth based on a single loss function of the end perception task, such as object detection or tracking. Training the implicit depth estimation based on the end perception task may lead to suboptimal depth estimation, and thus, suboptimal BEV features for further processing for the end perception task. In particular, the estimated depth distribution quality is typically inadequate as the depth estimation is only indirectly supervised by the perception task. Inaccurate depth estimation may lead to poor unprojection (e.g., transformation) of camera features to a BEV representation, which may lead to geometric distortion, ultimately impacting the performance of the perception task.

Given this drawback, this disclosure describes techniques that utilize auxiliary depth supervision in the perception model. More specifically, this disclosure describes techniques for combining depth data from a depth sensor with camera data to improve depth estimation of the camera data during a view transformation. Improved depth estimation may in turn improve the output of perception tasks performed using the combined depth data and camera data.

In a specific example of the disclosure, the depth sensor is a RADAR sensor. Given that RADAR sensors are typically low-cost, weather robust, and provide depth of each RADAR return, the data and corresponding features from the integration of RADAR data with camera data can help with improved BEV feature generation, which leads to improved overall task performance. While RADAR sensors are one type of depth sensor that may be used in conjunction with the techniques of this disclosure, other types of depth sensors that provide depth information for a scene corresponding to one or more camera images may also be used. Example depth sensors include ultrasonic sensors, RADAR sensors, LiDAR sensors, stereo cameras, infrared depth sensors, structured light sensors, and/or time-of-flight (ToF) camera sensors, among others. In some examples, the sensor used to capture the camera images may also be used as one part of a stereo camera setup (e.g., where then stereo camera setup uses two or more cameras).

In one example, this disclosure describes an apparatus configured for performing a perception task, the apparatus comprising a memory, and processing circuitry connected to the memory, the processing circuitry configured to receive a camera image of a scene from a camera sensor, receive depth data of the scene from a depth sensor, combine first information associated with the camera image with second information associated with the depth data to generate combined data, generate first features based on the combined data, generate second features based on the depth data, fuse the first features and the second features to generate fused features, and perform a perception task using the fused features.

In a more specific example, the apparatus configured for performing a perception task may be configured to receive a camera image of a scene from a camera sensor, receive depth data of the scene from a depth sensor, process the camera image with a first feature extractor to generate camera features, process the depth data with a second feature extractor to generate depth features, determine grids of the camera image based on the depth data, process the grids of the camera image with the first feature extractor to form ROI features, combine the camera features, the depth features, and the ROI features to generate combined features, and perform a perception task based on the combined features.

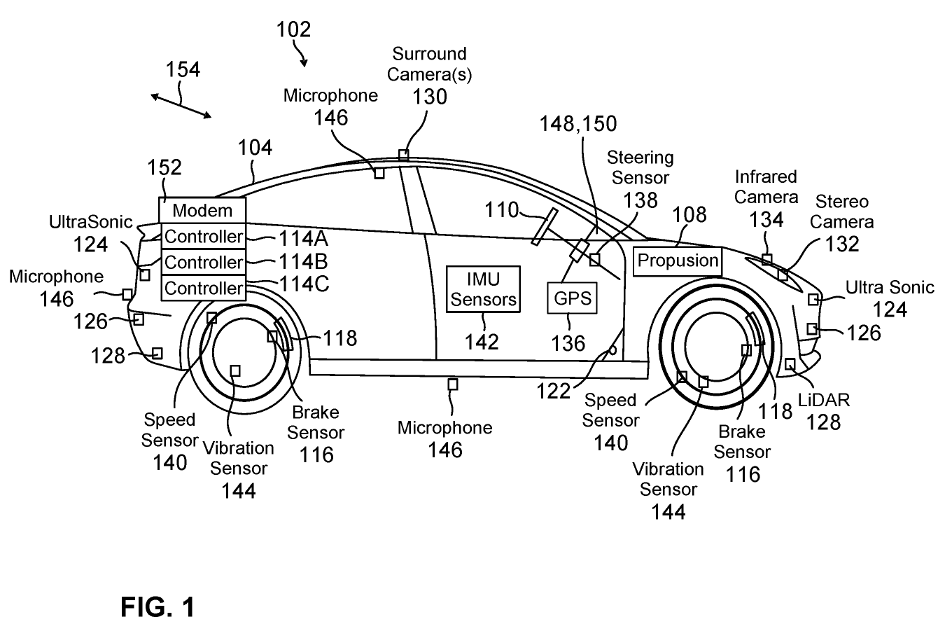

FIG. 1 shows an example vehicle 102 that may be configured to perform the perception tasks of this disclosure. Vehicle 102 in the example shown may comprise a passenger vehicle such as a car or truck that can accommodate a human driver and/or human passengers. In one example, vehicle 102 may comprise an autonomous vehicle or semi-autonomous vehicle. Vehicle 102 may include an ADAS. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the vehicle’s CAN bus and the controller 114, forwarding vehicle data to controller 114 including the turn signal, wheel speed, acceleration, pitch, roll, yaw, Global Positioning System (“GPS”) data, tire pressure, fuel level, SONAR, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs from the following sensors, including, for example: one or more ultrasonic sensors 124 (e.g., a SONAR sensor), one or more RADAR sensors 126, one or more LiDAR sensors 128, one or more surround cameras 130 (typically such cameras are located at various places on vehicle body 104 to image areas all around the vehicle body), one or more stereo cameras 132 (in one example, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle’s location, the location of other vehicles (including an occupancy grid) and even the Controller’s identification of objects and status. For example, HMI display 150 may alert the passenger when the controller 114 has identified the presence of a stop sign, caution sign, or changing traffic light and is taking appropriate action, giving the vehicle occupants peace of mind that the controller 114 is functioning as intended. In one example, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

As was described above, vehicle 102 preferably is configured with sensors that provide access to a 360-degreesurround representation of the environment for safe and efficient navigation. A multi-camera sensor and depth sensor system may be configured to reliably capture a complete surrounding representation around vehicle 102 by aggregating pixel level information from cameras 130-134 with depth, geometry, and/or velocity information from a depth sensor. The techniques of this disclosure are applicable for use with any type of depth sensor, including ultrasonic sensors 124, RADAR sensors 126, LiDAR sensors 128, and stereo cameras 132. In addition, though not shown in FIG. 1, other example depth sensors may be used in conjunction with the techniques of this disclosure, including infrared depth sensors, structured light sensors, and/or time-of-flight (ToF) camera sensors.

In some example perception models, 3D depth data from a depth sensor (e.g., a RADAR point cloud) is processed by a depth feature extractor to obtain depth feature vectors. The 3D depth features vectors may then be flattened into a birds-eye-view (BEV) representation. Additionally, one or more camera images captured at approximately the same time as the 3D depth data may be processed by a camera feature extractor to obtain camera feature vectors. These camera feature vectors may be processed by a view transformation to convert the camera features from perspective views into the same BEV representation as the depth feature vectors. One example of a view transformation is lift, shoot, splat. As part of the lift, shoot, splat process, implicit depth estimation is performed for each of the camera feature vectors.

A BEV representation in computer vision refers to a top-down perspective of a scene, as if viewed from above, similar to the perspective of a bird flying overhead. A BEV representation is particularly valuable in applications such as autonomous driving, robotics, and surveillance, where understanding the spatial layout and relationships between objects on the ground plane is beneficial. In the context of computer vision, generating a BEV representation involves transforming image data from one or more cameras into a top-down view. This top-down perspective simplifies various tasks in computer vision, such as object detection, tracking, and path planning, by reducing the complexity of the scene and offering a more intuitive understanding of spatial relationships. Additionally, as discussed above, BEV representations are often integrated with data from other sensors, such as LiDAR or RADAR, to enhance accuracy and robustness in dynamic and complex environments.

After transformation to the BEV representation, the depth feature vectors and the camera feature vectors may be fused into BEV feature vectors. One or more perception tasks, such as 3D object detection, lane detection, object tracking and segmentation tasks, may then be performed on the BEV feature vectors. The general perception model described above may be trained to learn an implicit depth representation for each pixel in the perspective view to transform features from perspective view to the BEV representation. However, the model is only trained to determine the implicit depth based on a single loss function of the end perception task, such as object detection or tracking. Training the implicit depth estimation based on the end perception task may lead to suboptimal depth estimation, and thus, suboptimal BEV features for further processing for the end perception task. In particular, the estimated depth distribution quality is typically inadequate as the depth estimation is only indirectly supervised by the perception task. Inaccurate depth estimation may lead to poor unprojection (e.g., transformation) of camera features to a BEV representation, which may lead to geometric distortion, ultimately impacting the performance of the perception task.

Given this drawback, this disclosure describes techniques that utilize auxiliary depth supervision in the perception model. More specifically, this disclosure describes techniques for combining depth data from a depth sensor with camera data to improve depth estimation of the camera data during a view transformation. Improved depth estimation may in turn improve the output of perception tasks performed using the combined depth data and camera data.

In a specific example of the disclosure, the depth sensor is a RADAR sensor. Given that RADAR sensors are typically low-cost, weather robust, and provide depth of each RADAR return, the data and corresponding features from the integration of RADAR data with camera data can help with improved BEV feature generation, which leads to improved overall task performance. While RADAR sensors are one type of depth sensor that may be used in conjunction with the techniques of this disclosure, other types of depth sensors that provide depth information for a scene corresponding to one or more camera images may also be used. Example depth sensors include ultrasonic sensors, RADAR sensors, LiDAR sensors, stereo cameras, infrared depth sensors, structured light sensors, and/or time-of-flight (ToF) camera sensors, among others. In some examples, the sensor used to capture the camera images may also be used as one part of a stereo camera setup (e.g., where then stereo camera setup uses two or more cameras).

In a more specific example of the disclosure, controller 114 is configured for performing a perception task and may be configured to combine first information associated with a camera image with second information associated with depth data from a depth sensor. In one example, the combining of the first information and the second information may occur “early” in a perception pipeline (e.g., before feature extraction) or may occur in a “middle” part of the perception pipeline (e.g., after feature extraction).

Accordingly, in an early fusion example of the disclosure, the first information associated with the camera image may be pixel values, while the second information associated with the depth data may be depth parameters (e.g., a RADAR cross section and absolute velocity in the context of a RADAR depth sensor). In a mid fusion example of the disclosure, the first information associated with the camera image may be feature vectors produced by processing the camera image with a camera feature extractor. Likewise, in the mid fusion example, the second information associated with the depth sensor may be feature vectors produced by processing the depth data with a depth feature extractor.

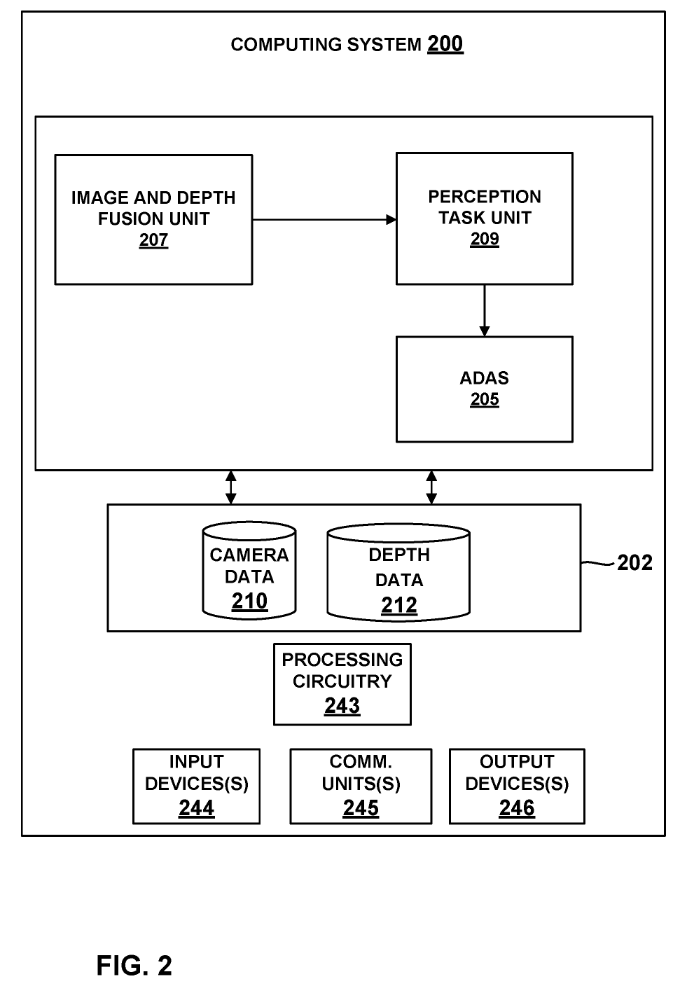

Regardless of when the first information and second information are combined to form the combined data, controller 114 may perform a view transformation (e.g., a birds-eye-view (BEV) transform) on features generated from the combined data. The view transformation process includes performing a depth estimation. Controller 114 may then fuse the transformed features generated from the combined data with features generated from the depth data to form fused BEV features. One or more perception tasks may then be performed on the fused BEV features. Perception tasks may include one or more of sematic segmentation, semantic occupancy prediction, lane tracking, object tracking, collision prediction, 3D object detection, or 3D object classification. Additional details on the perception techniques of this disclosure are described below with reference to FIGS. 2-7.

FIG. 2 is a block diagram illustrating an example computing system 200. As shown, computing system 200 comprises processing circuitry 243 and memory 202. The processing circuitry 243 is configured for executing image and depth fusion unit 207, perception task unit 209, and ADAS 205, which may represent an example instance of any controller 114 described in this disclosure, such as controller 114 of FIG. 1. The example of FIG. 2 shows image and depth fusion unit 207, perception task unit 209, and ADAS 205 as being separate units. In other examples, image and depth fusion unit 207 and perception task unit 209 may be a sub-units of ADAS 205.

Computing system 200 may be implemented as any suitable external computing system accessible by controller 114, such as one or more server computers, workstations, laptops, mainframes, cloud computing systems, High-Performance Computing (HPC) systems (e.g., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure for combining depth data with camera data to improve depth estimation of the camera data during a view transformation may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network – PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/deactivate cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., image and depth fusion unit 207, perception task unit 209, and/or ADAS 205), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute image and depth fusion unit 207, perception task unit 209, and/or ADAS 205 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a video camera, ranging or depth sensor (e.g., one or more of RADAR sensors, ultrasonic sensors, LiDAR sensors, etc.), keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, computing system 200 may be configured to execute image and depth fusion unit 207, perception task unit 209, and ADAS 205. Perception task unit 209 may be configured to perform one or more perception tasks using fused features generated by image and depth fusion unit 207. Image and depth fusion unit 207 may be configured to generate 3D sensor features from data from two or more sensors. In one example, the two or more sensors include a camera sensor (e.g., one of cameras 130 of FIG. 1) that produces camera data 210, and depth sensor that produces depth data 212. Example depth sensors may include ultrasonic sensors 124, RADAR sensors 126, LiDAR sensors 128, and stereo cameras 132, as shown in FIG. 1. In addition, though not shown in FIG. 1, other example depth sensors may be used in conjunction with the techniques of this disclosure, including infrared depth sensors, structured light sensors, and/or time-of-flight (ToF) camera sensors.

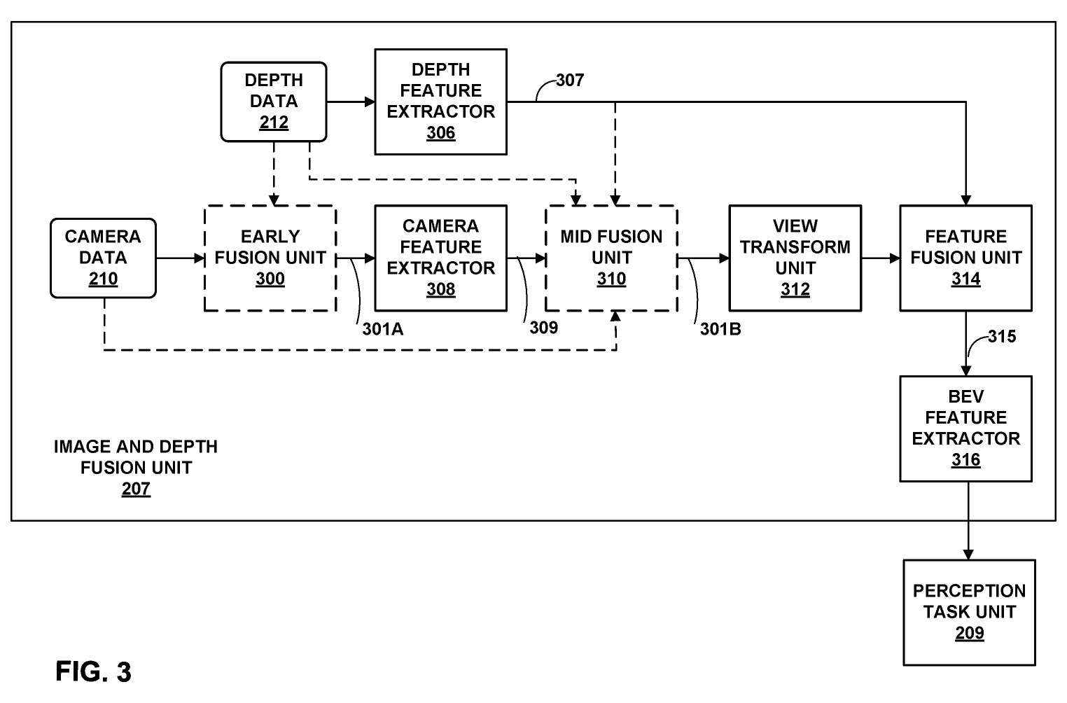

As will be explained in more detail below with reference to FIGS. 3-6, image and depth fusion unit 207 may be configured to receive a camera image of a scene from a camera sensor, receive depth data of the scene from a depth sensor, combine first information associated with the camera image with second information associated with the depth data to generate combined data, generate first features based on the combined data, generate second features based on the depth data, fuse the first features and the second features to generate fused features, and perform a perception task using the fused features.

FIG. 3 is a block diagram illustrating one example of the image and depth fusion unit 207 and perception task unit 209 of FIG. 2. In accordance with the techniques of this disclosure, image and depth fusion unit 207 may be configured to perform one or more of three general techniques for fusing depth data 212 with camera data 210 to provide auxiliary depth supervision for depth estimation by view transform unit 312. The three general techniques, as will be described below, may generally be referred to as early fusion, mid fusion, and spatially aware mid fusion, respectively.

Image and depth fusion unit 207 may be configured to receive camera data 210 and depth data 212. Camera data 210 may include one or more perspective view camera images received from a camera sensor (e.g., cameras 130 of FIG. 1). The techniques of this disclosure may be used with any number of camera images captured at the same time. That is, image and depth fusion unit 207 may be configured to form a BEV representation of a scene surrounding a vehicle using any number of camera images, including a single camera image. Camera data 210 may be individual frames of video data or still images of a scene.

Depth data 212 may be any time of depth data received from any type of depth sensor, as described above. In one example, depth data 212 may be a RADAR point cloud of the scene (or a portion of the scene) captured by one or more of the RADAR sensors. The RADAR point cloud may be received from one or more of RADAR sensors 126 of FIG. 1. A RADAR point cloud may include a plurality of depth parameters that define the points captured by the RADAR sensor. The depth parameters may include one or more of range, absolute velocity, azimuth angle, elevation angle, signal strength (also called RADAR cross section (RCS), and a time stamp. In general, the RADAR point cloud represents a set of points in 3D space the indicates the positions of detected objects. Range is the distance from the RADAR sensor to the detected object. Absolute velocity is the speed of the object relative to the RADAR sensor. Azimuth angle is the horizontal angle or direction of an object relative to the orientation of the RADAR sensor. Elevation angle is the vertical angle or height of an object relative to the position of the RADAR. RCS is the strength or amplitude of the returned signal. The time stamp indicates the time at which the RADAR measurement was made.

As mentioned above, image and depth fusion unit 207 may be configured to apply one or more general techniques for fusing depth data 212 with camera data 210. As such, early fusion unit 300 and mid fusion unit 310 are shown with dashed lines, as their use may be optional. That is, image and depth fusion unit 207 may be configured to apply only early fusion unit 300, only mid fusion unit 310, or both early fusion unit 300 and mid fusion unit 310. In examples where one of early fusion unit 300 or mid fusion unit 310 are not applied, the inputs to such unused units are passed through to the next unit with no alterations.

A first example technique is called early fusion, and may be performed by early fusion unit 300. Early fusion unit 300 may be configured to combine first information associated with a camera image from camera data 210 with second information associated with depth data 212 to generate combined data 301A before any feature vectors are extracted from camera data 210 or depth data 212. In the context of early fusion unit 300, the first information associated with the camera image may be pixel values (e.g., RGB values), while the second information associated with the depth data may be depth parameters (e.g., RCS, absolute velocity, and/or other depth parameters in the context of a RADAR depth sensor).

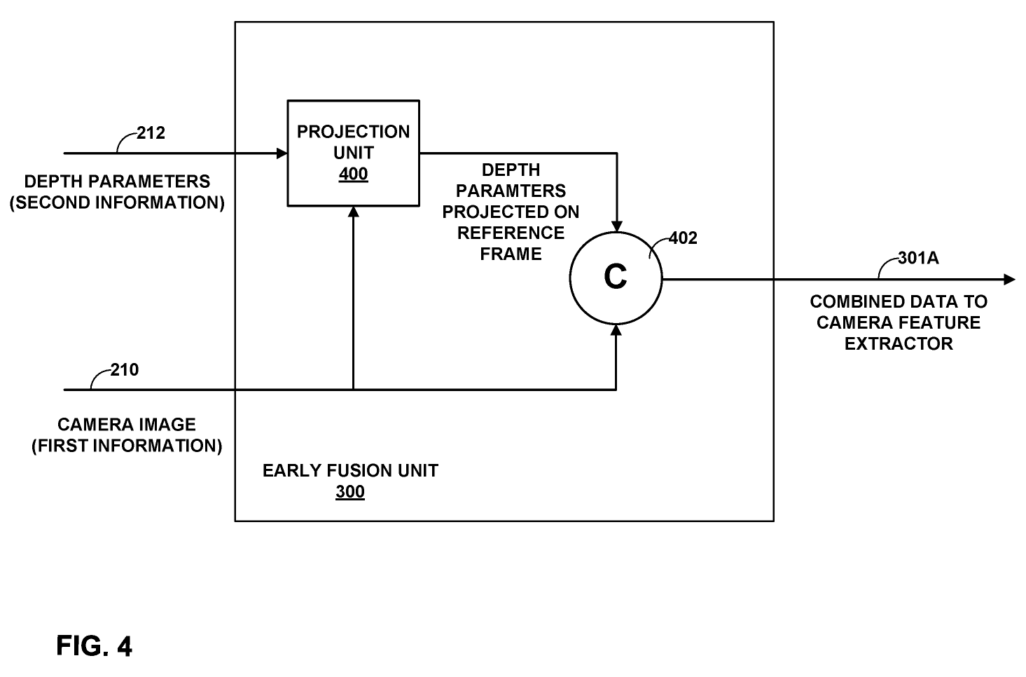

FIG. 4 is a block diagram illustrating an example of depth and camera fusion according to a first example of the disclosure. In particular, FIG. 4 shows one example of early fusion unit 300. Early fusion unit 300 may receive a camera image (e.g., the first information) from camera data 210 and may receive depth parameters (e.g., second information) from depth data 212. Projection unit 400 may project the depth parameters onto a reference frame associated with the camera image. In particular, projection unit 400 projects the depth parameters onto the reference frame such that the objects represented by the depth parameters are in the same approximate location as objects depicted in the camera image.

The depth parameters projected onto the reference frame are combined with the camera image by combiner 402 to form combined data 301A. Combiner 402 may be configured to perform one of a concatenation, multiplication, or addition of the first information and the second information to generate combined data 301A.

Returning to FIG. 3, combined data 301A may then be processed by camera feature extractor 308 to generate camera features 309 (e.g., first features). Likewise, depth data 212 may be processed by depth feature extractor 306 to form depth features 307 (e.g., second features). Camera feature extractor 308 and depth feature extractor 306 may be sensor-specific feature extractors that are configured to operate on specific data types to produce feature vectors. Feature vectors are high-dimensional representations that encapsulate the characteristics of an image or depth data in a compact form. One of several techniques may be used to generate feature vectors. Example techniques for feature extraction are described below.

One example for generating feature vectors uses a Scale-Invariant Feature Transform (SIFT), which detects key points in image data or point cloud data and describes them using local gradients. SIFT features are robust to changes in scale, rotation, and illumination, making them suitable for matching and recognition tasks. Another approach for feature vector generation is a Histogram of Oriented Gradients (HOG), which captures the distribution of gradient orientations in localized regions of an image data or point cloud data. HOG features are particularly effective for detecting objects and shapes, as they highlight edge information and structural patterns.

Another technique for feature vector generation uses convolutional neural networks (CNNs). CNNs include multiple layers of convolutional filters that learn to detect various patterns, such as edges, textures, and complex shapes, through hierarchical feature learning. CNNs are trained on large datasets and can generalize well to new image data or point cloud data. The output from the next to last layer of a CNN, often called the feature map, is typically flattened into a feature vector.

In other examples, vision transformers (ViTs) may be used for feature extraction. ViTs divide image data or point cloud data into smaller patches, treat each patch as a token, and process these tokens using self-attention mechanisms. This approach allows the model to capture long-range dependencies and contextual relationships across the entire image or point cloud.

In other examples, features may be extracted using a transformer encoder. Feature extraction using a transformer encoder involves leveraging a self-attention mechanism to capture complex dependencies and contextual information from input data, such as image data or point cloud data. Transformer encoders, originally designed for natural language processing tasks, have been adapted for various applications in computer vision due to their ability to model long-range relationships and global context effectively.

The process begins with dividing the input data into smaller, manageable units. In the case of image data or point cloud data, this involves splitting the input data into patches. Each patch is then flattened and embedded into a high-dimensional space using a learnable linear projection. Positional embeddings may be added to these patch embeddings to retain spatial information.

Once the patches are prepared, they are fed into the transformer encoder, which may include multiple layers of self-attention and feed-forward networks. Each encoder layer may have two main components: a multi-head self-attention mechanism and a position-wise feed-forward network. The self-attention mechanism computes attention scores for each patch relative to all other patches, allowing the model to focus on relevant parts of the input data contextually. These attention scores are used to weight the patches, capturing dependencies and interactions between different parts of the input data.

The multi-head self-attention mechanism enhances this process by allowing the model to attend to multiple aspects of the data simultaneously. The multi-head self-attention mechanism does so by projecting the input into several subspaces (e.g., heads), performing self-attention in each subspace independently, and then concatenating the results. This enables the model to capture diverse features and relationships from different perspectives.

Following the self-attention mechanism, the output may be processed by a position-wise feed-forward network, which may include two linear transformations with a rectified linear unit (ReLU) activation in between. The ReLU applies non-linear transformations to each patch independently, further refining the extracted features. The output from the feed-forward network is then passed to the next encoder layer, and this process is repeated for a predetermined number of layers. At the end of the transformer encoder, the output feature vectors from the final layer represent a set of features extracted from the input data.

In the context of early fusion where mid fusion unit 310 is not used, camera features 309 generated from combined data 301A are processed by view transform unit 312. View transform unit 312 may generate 3D camera features through a process of implicit unprojection (e.g., using a lift, splat, shoot technique), which involves transforming the 2D pixel coordinates into 3D space. View transform unit 312 may perform a 2D to 3D lifting operation, where for each pixel in the image, a distribution of possible depths is estimated. Instead of directly determining the depth of each pixel, the 2D to 3D lifting operation may generate a frustum-shaped set of points that represent possible locations the pixel could map to in 3D space.

Each pixel is thus lifted from its 2D image plane into a frustum of potential 3D positions. The 2D to 3D lifting operation may populate these frustums with context features, capturing both semantic and spatial information about the scene. View transform unit 312 may then “splat” these features onto a predefined 3D grid (e.g., in a BEV representation), which allows the combination of information from one or more cameras images into a unified 3D representation of the scene.

Feature fusion unit 314 may then fuse depth features 307 with the BEV camera features produced by view transform unit 312 to generate fused features 315. That is, fused BEV features 315 include both depth features 307 as well as camera features 309 that were generated from the combined data of depth parameters and camera pixels. In some examples, depth features 307 may first be projected from 3D representation into the top-down BEV representation. For example, feature fusion unit 314 may project depth features 307 directly into the BEV space and then may use splatting to spread the associated features across the BEV grid. In one example, each depth point, is projected onto the BEV plane. The features from the points are then distributed or "splatted" over the BEV grid cells they fall into, e.g., using a Gaussian kernel or other spreading functions to ensure smooth and continuous feature representation.

BEV feature extractor 316 may extract BEV features from the BEV featured 315 output by feature fusion unit 314. In particular, BEV feature extractor 316 may be configured to align BEV features produced by view transform unit 312 (e.g., generated from camera data 210) and depth feature extractor 306 (e.g., generated from depth data 212). In some examples, BEV feature extractor 316 may be optional. Perception task unit 209 may use the fused features in various autonomous perception tasks with task-specific transformer decoder heads. For example, perception task unit 209 may include task specific transformer decoders or other machine learning units that are configured to perform one or more of sematic segmentation, semantic occupancy prediction, lane tracking, object tracking, collision prediction, 3D object detection, or 3D object classification.

In summary, when utilizing early fusion unit 300, image and depth fusion unit 207 is configured to extract features from depth parameters that are coherent with image data (e.g., RGB pixel data). As such, auxiliary depth data is added to the camera feature extraction process, thus making depth information estimated by view transform unit 312 to be more accurate. As such, since the depth information estimated by view transform unit 312 is more accurate, the output of perception task unit 209 may also be more accurate.

A second example technique is called mid fusion and may be performed by mid fusion unit 310. Mid fusion unit 310 may be operable together with early fusion unit 300 or may be operable alone. The following description is for operation of mid fusion unit 310 alone. In this case, camera data 210 is processed by camera feature extractor 308 to produce camera features 309. Accordingly, in the context of mid fusion, the first information associated with the camera image are camera features 309. Likewise, in the mid fusion example, the second information associated with the depth sensor may be depth features 307 produced by processing depth data 212 with depth feature extractor 306. Accordingly, mid fusion unit 310 is configured to combine camera features 309 (e.g., the first information in the context of mid fusion) with depth features 307 (e.g., the second information in the context of mid fusion). As such, in mid fusion, the combination of a camera image with depth data happens in the feature vector space after feature extraction.

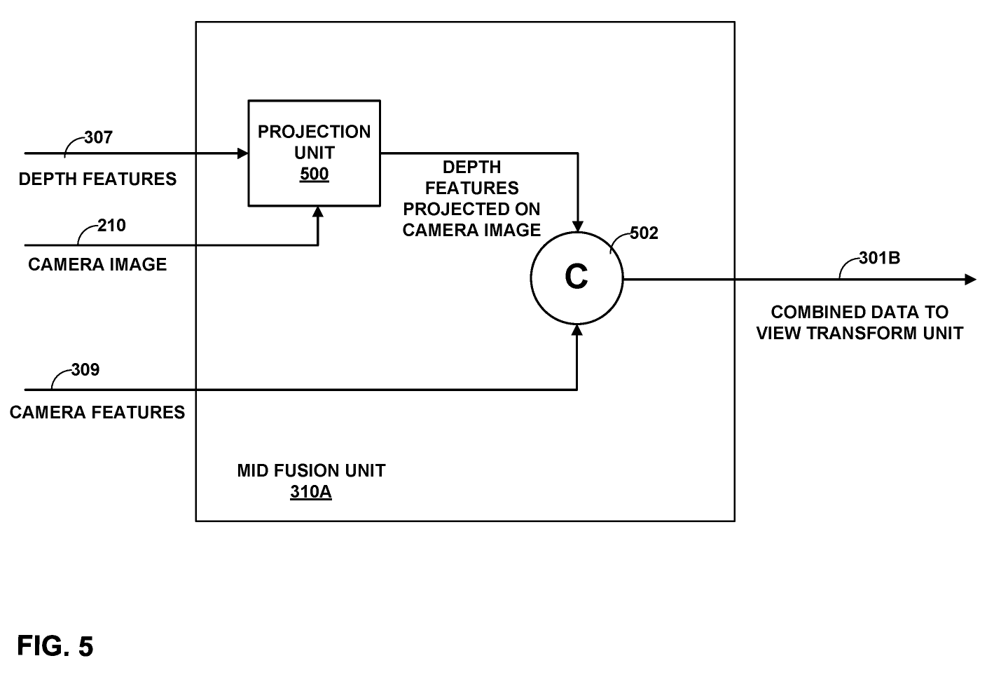

FIG. 5 is a block diagram illustrating another example of depth and camera fusion according to a second example of the disclosure. In particular, FIG. 5 shows mid fusion unit 310A, which is one example of mid fusion unit 310. Mid fusion unit 310A may receive camera features 309 (e.g., the first information), a camera image from camera data 210 for use as a reference frame, and depth features 307 (e.g., the second information). Projection unit 500 may project the depth features 307 onto a reference frame associated with the camera features. In particular, projection unit 500 projects the depth features onto the reference frame such that the objects represented by the depth features are in the same approximate location as objects depicted in the camera image.

The depth features projected onto the reference frame are combined with camera features 309 by combiner 502 to form combined data 301B. Combiner 502 may be configured to perform one of a concatenation, multiplication, or addition of the first information and the second information to generate combined data 301B. Returning to FIG. 3, combined data 301B is processed by the remaining units of image and depth fusion unit 207 as described above.

A third example technique is called spatially aware mid fusion and may also be performed by mid fusion unit 310. In this case, camera data 210 is again processed by camera feature extractor 308 to produce camera features 309. Accordingly, in the context of spatially aware mid fusion, the first information associated with the camera image are camera features 309. Likewise, in the spatially aware mid fusion example, the second information associated with the depth sensor may be depth features 307 produced by processing depth data 212 with depth feature extractor 306. Accordingly, mid fusion unit 310 is configured to combine camera features 309 (e.g., the first information in the context of mid fusion) with depth features 307 (e.g., the second information in the context of mid fusion). As such, in mid fusion, the combination of a camera image with depth data happens in the feature vector space after feature extraction.

In addition, to perform spatially aware mid fusion, mid fusion unit 310 may be configured to utilize image-encoded depth features by projecting depth parameters onto an image. Mid fusion unit 310 may be further configured to extract a grid centered around depth parameters representative of an object from the camera image. The grids may be of different sizes. The grids may then be processed by a feature extractor and may be region-of-interest (ROI) aligned to form spatially aware aligned features (e.g., aligned third information). The camera features, depth features, and spatially aware aligned features may then be combined.

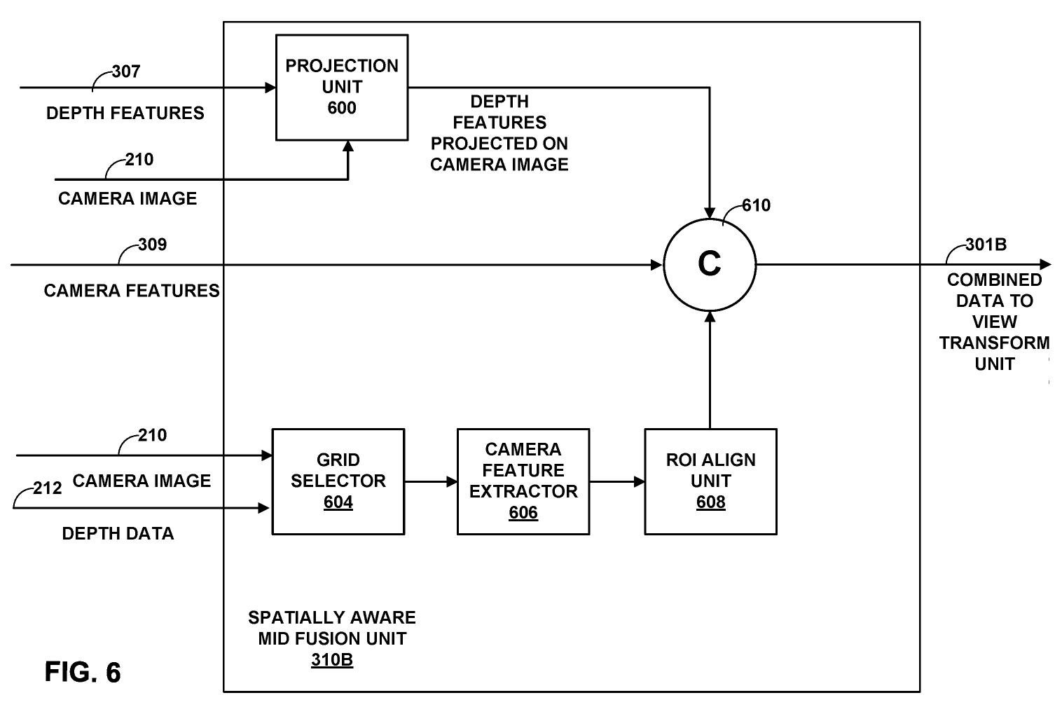

In summary, with reference to both FIG. 3 and FIG. 6, image and depth fusion unit 207 may be configured to receive a camera image from camera data 210 of a scene from a camera sensor and may receive depth data 212 of the scene from a depth sensor. Image and depth fusion unit 207 may process the camera image with a first feature extractor (e.g., camera feature extractor 308) to generate camera features 309. Image and depth fusion unit 207 may also process depth data 212 with a second feature extractor (e.g., depth feature extractor 306) to generate depth features 307.

Spatially aware mid fusion unit 310B may determine grids (e.g., using grid selector 604) of the camera image based on depth data 212. Spatially aware mid fusion unit 310B may process the grids of the camera image with a feature extractor (e.g., camera feature extractor 606) to form ROI features. Note that camera feature extractor 606 may be the same feature extractor as camera feature extractor 308 of FIG. 3. In other examples, camera feature extractor 606 may be a different feature extractor. Spatially aware mid fusion unit 310B may then ROI align the ROI features to form aligned features, and combine (e.g., using combiner 610), camera features 309, depth features 307, and aligned features to form combined data 301B (e.g., combined features).

Returning to FIG. 3, image and depth fusion unit 207 may then fuse depth features 307 and combined data 301B (e.g., combined features) to form the fused features. Image and depth fusion unit 207 may then perform a perception task (e.g., using perception task unit 209) using the fused features.

FIG. 6 is a block diagram illustrating another example of depth and camera fusion according to a third example of the disclosure. In particular, FIG. 6 shows spatially aware mid fusion unit 310B, which is one example of mid fusion unit 310. Spatially aware mid fusion unit 310B is configured to perform spatially aware mid fusion. Like the example of FIG. 5, spatially aware mid fusion unit 310B may receive camera features 309 (e.g., the first information), a camera image from camera data 210 for use as a reference frame, and depth features 307 (e.g., the second information). Projection unit 600 may project the depth features 307 onto a reference frame associated with the camera features. In particular, projection unit 600 projects the depth features onto the reference frame such that the objects represented by the depth features are in the same approximate location as objects depicted in the camera image.

Spatially aware mid fusion unit 310B is also configured to receive depth parameters from depth data 212 and a camera image from camera data 210 that corresponds to camera features 309. Grid selector 604 projects the depth parameters onto the camera image and determines grids of various sizes (e.g., 5x5, 9x9, etc.) that capture important regions-of-interest (ROIs) in the image. That is, grid selector 604 extracts various grids or regions of the camera image that have associated depth parameters (e.g., RADAR returns) projected thereon. The presence of associated depth parameters in the image indicates that such regions or grids of the image include pixel values representing objects, and thus may be more important for downstream perception tasks. Camera feature extractor 606 (which may be the same as camera feature extractor 308 of FIG. 3), then extracts camera features (e.g., third information) from just the grids of image data extracted by grid selector 604.

ROI align unit 608 then aligns the grids of image features produced by camera feature extractor 606 to a common size (e.g., aligned third information), as the grids output by grid selector 604 may be of varying sizes. For example, grid selector 604 and camera feature extractor 606 may perform an ROI pooling operation (e.g., RoIPool) that extracts a small feature map (e.g., a 7×7 grid) from each ROI. Grid selector 604 may perform quantization on continuous coordinates when dividing the image into grids. The quantization may introduce misalignments between the pixels of the ROI and the extracted features. As such, ROI align unit 608 may be configured to remove or soften the quantization, with may better align the extracted features with the input pixels in the grids. ROI align unit 608 may avoid any quantization of the grid boundaries by using bi-linear interpolation to compute the values of the input features at regularly sampled locations in each grid. ROI align unit 608 may aggregate the results (e.g., using max or average functions).

In some examples, grid selector 604 may be configured to output grids of constant size. In this example, ROI alignment may not be necessary.

Combiner 602 may combine the depth features projected onto the reference frame, camera features 309, as well as the ROI features to form combined data 301B. The ROI features may be those output by camera feature extractor 606 (e.g., ROI features), or may be aligned features output by ROI align unit 608 in the case that ROI alignment is performed. Combiner 602 may be configured to perform one of a concatenation, multiplication, or addition of the first information and the second information to generate combined data 301B. Spatially aware mid fusion unit 310B combines by camera features 309 as well as the ROI aligned features to account for any missed data (e.g., missed objects) in the depth data. Returning to FIG. 3, combined data 301B is processed by the remaining units of image and depth fusion unit 207 as described above.

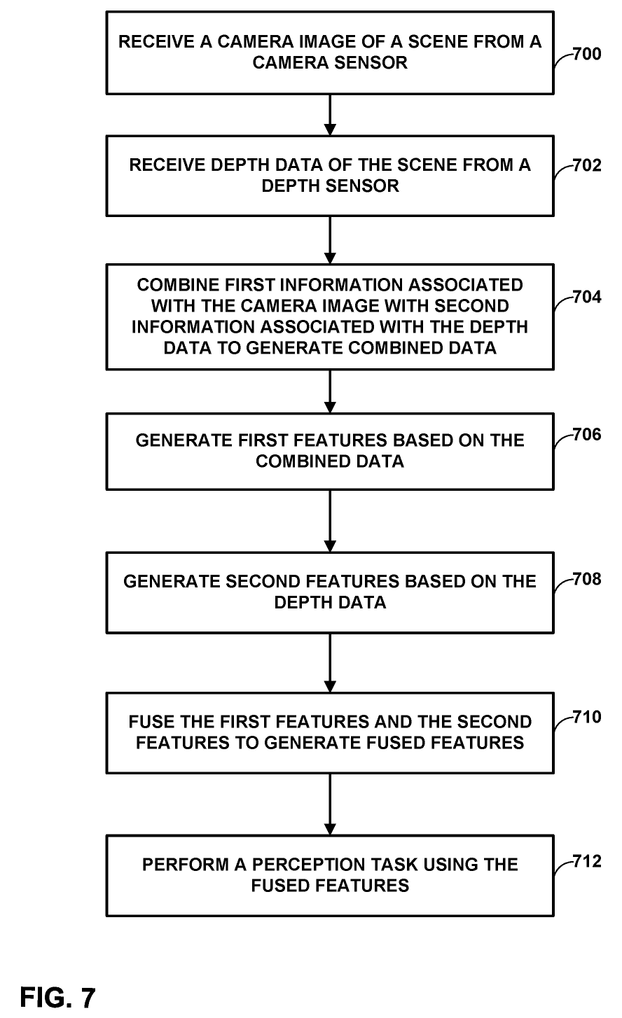

FIG. 7 is a flowchart illustrating an example process in accordance with the techniques of this disclosure. The techniques of FIG. 7 may be performed by one or more controller 114 of FIG. 1 and/or computing system 200. For ease of description, FIG. 7 will be described with reference to computing system 200.

Computing system 200 may be configured to receive a camera image of a scene from a camera sensor (700), and receive depth data of the scene from a depth sensor (702). Computing system 200 may be further configured to combine first information associated with the camera image with second information associated with the depth data to generate combined data (704). Computer system 200 may further generate first features based on the combined data (706), generate second features based on the depth data (708), and fuse the first features and the second features to generate fused features (710). In some examples, computing system 200 may be configured to transform the first features into a BEV representation with depth estimation prior to performing the perception task. Computing system may then perform a perception task using the fused features (712). The perception task includes one or more of sematic segmentation, semantic occupancy prediction, lane tracking, object tracking, collision prediction, 3D object detection, or 3D object classification.

In an early fusion example of the disclosure, the first information associated with the camera image includes pixel data, and the second information associated with the depth data includes parameters of the depth data. In this early fusion example, to generate the first features based the combined data, computing system 200 is configured to process the combined data using a first feature extractor to generate the first features.

In a mid fusion example of the disclosure, computing system 200 may be configured to process the camera image with a first feature extractor to generate the first information. Computing system 200 may be further configured to project the second features onto the camera image to form the second information. In this mid fusion example, to generate the second features based on the depth data, computing system 200 is configured to process the depth data with a second feature extractor to generate the second features. To combine the first information associated with the camera image with the second information associated with the depth data to generate combined data, computing system 200 may be configured to perform one of a concatenation, multiplication, or addition of the first information and the second information to generate the combined data.

In a spatially aware mid fusion example of the disclosure, in addition to the techniques described above for mid fusion, computing system 200 may be further configured to determine grids of the camera image based on the depth data, process the grids of the camera image with the first feature extractor to form third information, and region-of-interest (ROI) align the third information to form aligned third information. To combine the first information associated with the camera image with the second information associated with the depth data to generate combined data, computing system 200 may be configured to perform one of a concatenation, multiplication, or addition of the first information, the second information, and the aligned third information to generate the combined data.

In any of the above examples of FIG. 7, computing system 200 may be part of an automobile which includes the camera sensor and the depth sensor. The depth sensor may be one or more of a RARDAR sensor, a LiDAR sensor, a SONAR sensor, a time-of-flight (ToF) camera sensor, a stereo camera sensor, an infrared depth sensor, or a structured light sensor.

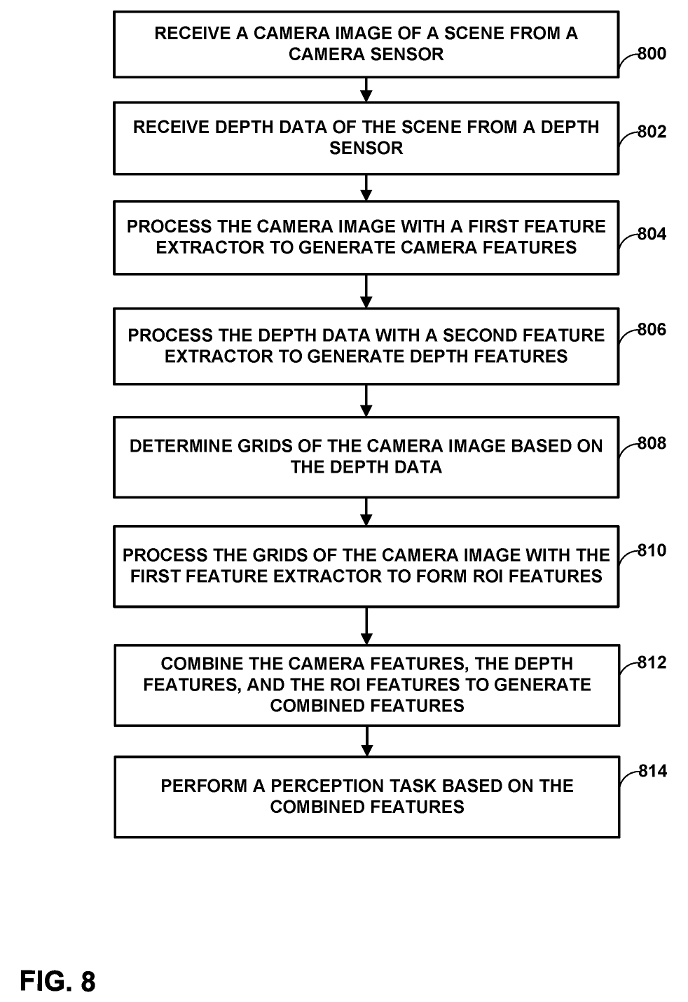

FIG. 8 is a flowchart illustrating an example process in accordance with the techniques of this disclosure. The techniques of FIG. 8 may be performed by one or more controller 114 of FIG. 1 and/or computing system 200. For ease of description, FIG. 8 will be described with reference to computing system 200.

Computing system 200 may be configured to receive a camera image of a scene from a camera sensor (800) and receive depth data of the scene from a depth sensor (802). Computing system may further process the camera image with a first feature extractor to generate camera features (804), and process the depth data with a second feature extractor to generate depth features (806).

To perform a spatially aware mid fusion process, computing system 200 may determine grids of the camera image based on the depth data (808), process the grids of the camera image with the first feature extractor to form ROI features (810). In some examples, computing system 200 may region-of-interest (ROI) align the ROI features to pixels of the grids to form aligned features. Computing system 200 may further combine the camera features, the depth features, and the ROI features (or aligned features) to generate combined features (812). To combine the camera features, the depth features, and the ROI features to generate the combined features, computing system 200 may be configured to perform one of a concatenation, multiplication, or addition of the depth features, and the ROI features to generate the combined features. In some examples, computing system 200 may project the depth features onto the camera image prior to combining the camera features, the depth features, and the ROI features to generate the combined features.

In some examples, computing system 200 may further fuse the depth features and the combined features to generate fused features. In addition, computing system 200 may be configured to transform the combined features into a birds-eye-view (BEV) representation with depth estimation prior to performing the perception task. Computing system 200 may perform a perception task based on the combined features (814). That is, computing system 200 may perform a perception task using the combined features alone, or may perform the perception task based on fused features formed from the combined features and the depth features. The perception task may include one or more of sematic segmentation, semantic occupancy prediction, lane tracking, object tracking, collision prediction, 3D object detection, or 3D object classification.

In any of the above examples of FIG. 8, computing system 200 may be part of an automobile which includes the camera sensor and the depth sensor. The depth sensor may be one or more of a RARDAR sensor, a LiDAR sensor, a SONAR sensor, a time-of-flight (ToF) camera sensor, a stereo camera sensor, an infrared depth sensor, or a structured light sensor. Computing system 200 may be part of an ADAS.

The following numbered clauses illustrate one or more aspects of the devices and techniques described in this disclosure.

Aspect 1. An apparatus for performing a perception task, the apparatus comprising: one or more memories; and processing circuitry in communication with the one or more memories, the processing circuitry configured to: receive a camera image of a scene from a camera sensor; receive depth data of the scene from a depth sensor; combine first information associated with the camera image with second information associated with the depth data to generate combined data; generate first features based on the combined data; generate second features based on the depth data; fuse the first features and the second features to generate fused features; and perform a perception task using the fused features.

Aspect 2. The apparatus of Aspect 1, wherein the processing circuitry is further configured to: transform the first features into a birds-eye-view (BEV) representation with depth estimation prior to generating the fused features.

Aspect 3. The apparatus of any of Aspects 1-2, wherein the first information associated with the camera image includes pixel data, wherein the second information associated with the depth data includes parameters of the depth data, and wherein to generate the first features based the combined data, the processing circuitry is further configured to: process the combined data using a first feature extractor to generate the first features.

Aspect 4. The apparatus of Aspect 1, wherein the processing circuitry is further configured to: process the camera image with a first feature extractor to generate the first information, and wherein to generate the second features based on the depth data, the processing circuitry is configured to: process the depth data with a second feature extractor to generate the second features.

Aspect 5. The apparatus of Aspect 4, wherein the processing circuitry is further configured to: project the second features onto the camera image to form the second information.

Aspect 6. The apparatus of Aspect 5, wherein to combine the first information associated with the camera image with the second information associated with the depth data to generate combined data, the processing circuitry is configured to: perform one of a concatenation, multiplication, or addition of the first information and the second information to generate the combined data.

Aspect 7. The apparatus of Aspect 5, wherein the processing circuitry is further configured to: determine grids of the camera image based on the depth data; process the grids of the camera image with the first feature extractor to form third information; and region-of-interest (ROI) align the third information to form aligned third information.

Aspect 8. The apparatus of Aspect 7, wherein to combine the first information associated with the camera image with the second information associated with the depth data to generate combined data, the processing circuitry is configured to: perform one of a concatenation, multiplication, or addition of the first information, the second information, and the aligned third information to generate the combined data.

Aspect 9. The apparatus of any of Aspects 1-8, wherein the perception task includes one or more of sematic segmentation, semantic occupancy prediction, lane tracking, object tracking, collision prediction, 3D object detection, or 3D object classification.

Aspect 10. The apparatus of any of Aspects 1-9, wherein the apparatus is an automobile, wherein the apparatus further includes the camera sensor and the depth sensor, and wherein the depth sensor is one of a RADAR sensor, a LiDAR sensor, a SONAR sensor, a time-of-flight (ToF) camera sensor, a stereo camera sensor, an infrared depth sensor, or a structured light sensor.

Aspect 11. A method for performing a perception task, the method comprising: receiving a camera image of a scene from a camera sensor; receiving depth data of the scene from a depth sensor; combining first information associated with the camera image with second information associated with the depth data to generate combined data; generating first features based on the combined data; generating second features based on the depth data; fusing the first features and the second features to generate fused features; and performing a perception task using the fused features.

Aspect 12. The method of Aspect 11, further comprising: transforming the first features into a birds-eye-view (BEV) representation with depth estimation prior to generating the fused features.

Aspect 13. The method of any of Aspects 11-12, wherein the first information associated with the camera image includes pixel data, wherein the second information associated with the depth data includes parameters of the depth data, and wherein generating the first features based the combined data comprises: processing the combined data using a first feature extractor to generate the first features.

Aspect 14. The method of Aspect 11, further comprising: processing the camera image with a first feature extractor to generate the first information, and wherein generating the second features based on the depth data comprises: processing the depth data with a second feature extractor to generate the second features.

Aspect 15. The method of Aspect 14, further comprising: projecting the second features onto the camera image to form the second information.

Aspect 16. The method of Aspect 15, wherein combining the first information associated with the camera image with the second information associated with the depth data to generate combined data comprises: performing one of a concatenation, multiplication, or addition of the first information and the second information to generate the combined data.

Aspect 17. The method of Aspect 15, further comprising: determining grids of the camera image based on the depth data; processing the grids of the camera image with the first feature extractor to form third information; and region-of-interest (ROI) aligning the third information to form aligned third information.

Aspect 18. The method of Aspect 17, wherein combining the first information associated with the camera image with the second information associated with the depth data to generate combined data comprises: performing one of a concatenation, multiplication, or addition of the first information, the second information, and the aligned third information to generate the combined data.

Aspect 19. The method of any of Aspects 11-18, wherein the perception task includes one or more of sematic segmentation, semantic occupancy prediction, lane tracking, object tracking, collision prediction, 3D object detection, or 3D object classification.

Aspect 20. A non-transitory computer-readable storage medium storing instructions that, when executed, cause one or more processors of a device configured to perform a perception task to: receive a camera image of a scene from a camera sensor; receive depth data of the scene from a depth sensor; combine first information associated with the camera image with second information associated with the depth data to generate combined data; generate first features based on the combined data; generate second features based on the depth data; fuse the first features and the second features to generate fused features; and perform a perception task using the fused features.

Aspect 21. An apparatus for performing a perception task, the apparatus comprising: one or more memories; and processing circuitry in communication with the one or more memories, the processing circuitry configured to: receive a camera image of a scene from a camera sensor; receive depth data of the scene from a depth sensor; process the camera image with a first feature extractor to generate camera features; process the depth data with a second feature extractor to generate depth features; determine grids of the camera image based on the depth data; process the grids of the camera image with the first feature extractor to form ROI features; combine the camera features, the depth features, and the ROI features to generate combined features; and perform a perception task based on the combined features.

Aspect 22. The apparatus of Aspect 21, wherein the processing circuitry is further configured to: region-of-interest (ROI) align the ROI features to pixels of the grids to form aligned features, and wherein to combine the camera features, the depth features and the ROI features to generate the combined features, the processing circuitry is configured to combine the camera features, the depth features and the aligned features to generate the combined features.

Aspect 23. The apparatus of any of Aspects 21-22, wherein the processing circuitry is further configured to: transform the combined features into a birds-eye-view (BEV) representation with depth estimation prior to performing the perception task; and fuse the depth features and the combined features to generate fused features, and wherein to perform the perception task, the processing circuitry is configured to perform the perception task using the fused features.

Aspect 24. The apparatus of any of Aspects 21-23, wherein the processing circuitry is further configured to: project the depth features onto the camera image prior to combining the camera features, the depth features, and the ROI features to generate the combined features.

Aspect 25. The apparatus of any of Aspects 21-24, wherein to combine the camera features, the depth features, and the ROI features to generate the combined features, the processing circuitry is configured to: perform one of a concatenation, multiplication, or addition of the depth features, and the ROI features to generate the combined features.

Aspect 26. The apparatus of any of Aspects 21-25, wherein the perception task includes one or more of sematic segmentation, semantic occupancy prediction, lane tracking, object tracking, collision prediction, 3D object detection, or 3D object classification.

Aspect 27. The apparatus of any of Aspects 21-26, wherein the processing circuitry is part of an advanced driver assistance system (ADAS).

Aspect 28. The apparatus of any of Aspects 21-27, wherein the apparatus is an automobile, and wherein the apparatus further includes the camera sensor and the depth sensor.

Aspect 29. The apparatus of Aspect 28, wherein the depth sensor is one of a RADAR sensor, a LiDAR sensor, a SONAR sensor, a time-of-flight (ToF) camera sensor, a stereo camera sensor, an infrared depth sensor, or a structured light sensor.

Aspect 30. A method of performing a perception task, the method comprising: receiving a camera image of a scene from a camera sensor; receiving depth data of the scene from a depth sensor; processing the camera image with a first feature extractor to generate camera features; processing the depth data with a second feature extractor to generate depth features; determining grids of the camera image based on the depth data; processing the grids of the camera image with the first feature extractor to form ROI features; combining the camera features, the depth features, and the ROI features to generate combined features; and performing a perception task based on the combined features.

Aspect 31. The method of Aspect 30, further comprising: region-of-interest (ROI) aligning the ROI features to pixels of the grids to form aligned features, and wherein combining the camera features, the depth features and the ROI features to generate the combined features comprises combining the camera features, the depth features and the aligned features to generate the combined features.

Aspect 32. The method of any of Aspects 30-31, further comprising: transforming the combined features into a birds-eye-view (BEV) representation with depth estimation prior to performing the perception task; and fusing the depth features and the combined features to generate fused features, and wherein performing the perception task comprises performing the perception task using the fused features.

Aspect 33. The method of any of Aspects 30-32, further comprising: projecting the depth features onto the camera image prior to combining the camera features, the depth features, and the ROI features to generate the combined features.

Aspect 34. The method of any of Aspects 30-33, wherein combining the camera features, the depth features, and the ROI features to generate the combined features comprises: performing one of a concatenation, multiplication, or addition of the depth features, and the ROI features to generate the combined features.

Aspect 35. The method of any of Aspects 30-34, wherein the perception task includes one or more of sematic segmentation, semantic occupancy prediction, lane tracking, object tracking, collision prediction, 3D object detection, or 3D object classification.

Aspect 36. The method of any of Aspects 30-35, wherein the method is performed by an advanced driver assistance system (ADAS).

Aspect 37. A non-transitory computer-readable storage medium storing instructions that, when executed, cause one or more processors of a device configured to perform a perception task to: receive a camera image of a scene from a camera sensor; receive depth data of the scene from a depth sensor; process the camera image with a first feature extractor to generate camera features; process the depth data with a second feature extractor to generate depth features; determine grids of the camera image based on the depth data; process the grids of the camera image with the first feature extractor to form ROI features; combine the camera features, the depth features, and the ROI features to generate combined features; and perform a perception task based on the combined features.

Aspect 38. The non-transitory computer-readable storage medium of Aspect 37, wherein the instructions further cause the one or more processors to: region-of-interest (ROI) align the ROI features to pixels of the grids to form aligned features, and wherein to combine the camera features, the depth features and the ROI features to generate the combined features, the instructions further cause the one or more processors to combine the camera features, the depth features and the aligned features to generate the combined features.

Aspect 39. The non-transitory computer-readable storage medium of any of Aspects 37-38, wherein instructions further cause the one or more processors to: transform the combined features into a birds-eye-view (BEV) representation with depth estimation prior to performing the perception task; and fuse the depth features and the combined features to generate fused features, and wherein to perform the perception task, the instructions further cause the one or more processors to perform the perception task using the fused features.

Aspect 40. The non-transitory computer-readable storage medium of any of Aspects 37-39, wherein instructions further cause the one or more processors to: project the depth features onto the camera image prior to combining the camera features, the depth features, and the ROI features to generate the combined features.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for performing a perception task, the apparatus comprising:
one or more memories; and
processing circuitry in communication with the one or more memories, the processing circuitry configured to:
receive a camera image of a scene from a camera sensor;
receive depth data of the scene from a depth sensor;
process the camera image with a first feature extractor to generate camera features;
process the depth data with a second feature extractor to generate depth features;
determine grids of the camera image based on the depth data;
process the grids of the camera image with the first feature extractor to form ROI features;
combine the camera features, the depth features, and the ROI features to generate combined features; and
perform a perception task based on the combined features.

2. The apparatus of claim 1, wherein the processing circuitry is further configured to:
region-of-interest (ROI) align the ROI features to pixels of the grids to form aligned features, and
wherein to combine the camera features, the depth features and the ROI features to generate the combined features, the processing circuitry is configured to combine the camera features, the depth features and the aligned features to generate the combined features.

3. The apparatus of claim 1, wherein the processing circuitry is further configured to:
transform the combined features into a birds-eye-view (BEV) representation with depth estimation prior to performing the perception task; and
fuse the depth features and the combined features to generate fused features, and
wherein to perform the perception task, the processing circuitry is configured to perform the perception task using the fused features.

4. The apparatus of claim 1, wherein the processing circuitry is further configured to:
project the depth features onto the camera image prior to combining the camera features, the depth features, and the ROI features to generate the combined features.

5. The apparatus of claim 1, wherein to combine the camera features, the depth features, and the ROI features to generate the combined features, the processing circuitry is configured to:
perform one of a concatenation, multiplication, or addition of the depth features, and the ROI features to generate the combined features.

6. The apparatus of claim 1, wherein the perception task includes one or more of sematic segmentation, semantic occupancy prediction, lane tracking, object tracking, collision prediction, 3D object detection, or 3D object classification.

7. The apparatus of claim 1, wherein the processing circuitry is part of an advanced driver assistance system (ADAS).

8. The apparatus of claim 1, wherein the apparatus is an automobile, and wherein the apparatus further includes the camera sensor and the depth sensor.

9. The apparatus of claim 8, wherein the depth sensor is one of a RADAR sensor, a LiDAR sensor, a SONAR sensor, a time-of-flight (ToF) camera sensor, a stereo camera sensor, an infrared depth sensor, or a structured light sensor.

10. A method of performing a perception task, the method comprising:
receiving a camera image of a scene from a camera sensor;
receiving depth data of the scene from a depth sensor;
processing the camera image with a first feature extractor to generate camera features;
processing the depth data with a second feature extractor to generate depth features;
determining grids of the camera image based on the depth data;
processing the grids of the camera image with the first feature extractor to form ROI features;
combining the camera features, the depth features, and the ROI features to generate combined features; and
performing a perception task based on the combined features.

11. The method of claim 10, further comprising:
region-of-interest (ROI) aligning the ROI features to pixels of the grids to form aligned features, and
wherein combining the camera features, the depth features and the ROI features to generate the combined features comprises combining the camera features, the depth features and the aligned features to generate the combined features.

12. The method of claim 10, further comprising:
transforming the combined features into a birds-eye-view (BEV) representation with depth estimation prior to performing the perception task; and
fusing the depth features and the combined features to generate fused features, and
wherein performing the perception task comprises performing the perception task using the fused features.

13. The method of claim 10, further comprising:
projecting the depth features onto the camera image prior to combining the camera features, the depth features, and the ROI features to generate the combined features.

14. The method of claim 10, wherein combining the camera features, the depth features, and the ROI features to generate the combined features comprises:
performing one of a concatenation, multiplication, or addition of the depth features, and the ROI features to generate the combined features.

15. The method of claim 10, wherein the perception task includes one or more of sematic segmentation, semantic occupancy prediction, lane tracking, object tracking, collision prediction, 3D object detection, or 3D object classification.

16. The method of claim 10, wherein the method is performed by an advanced driver assistance system (ADAS).

17. A non-transitory computer-readable storage medium storing instructions that, when executed, cause one or more processors of a device configured to perform a perception task to:
receive a camera image of a scene from a camera sensor;
receive depth data of the scene from a depth sensor;
process the camera image with a first feature extractor to generate camera features;
process the depth data with a second feature extractor to generate depth features;
determine grids of the camera image based on the depth data;
process the grids of the camera image with the first feature extractor to form ROI features;
combine the camera features, the depth features, and the ROI features to generate combined features; and
perform a perception task using the combined features.

18. The non-transitory computer-readable storage medium of claim 17, wherein the instructions further cause the one or more processors to:
region-of-interest (ROI) align the ROI features to pixels of the grids to form aligned features, and
wherein to combine the camera features, the depth features and the ROI features to generate the combined features, the instructions further cause the one or more processors to combine the camera features, the depth features and the aligned features to generate the combined features.

19. The non-transitory computer-readable storage medium of claim 17, wherein instructions further cause the one or more processors to:
transform the combined features into a birds-eye-view (BEV) representation with depth estimation prior to performing the perception task; and
fuse the depth features and the combined features to generate fused features, and
wherein to perform the perception task, the instructions further cause the one or more processors to perform the perception task using the fused features.

20. The non-transitory computer-readable storage medium of claim 17, wherein instructions further cause the one or more processors to:
project the depth features onto the camera image prior to combining the camera features, the depth features, and the ROI features to generate the combined features.
